(19) United States
(12) Patent Application Publication
(10) Pub. No.: US 2024/0297404 A1
(43) Pub. Date: Sep. 5, 2024

(54) INTEGRATED FILTERING SYSTEMS FOR TRACTION BATTERY PACKS

(71) Applicant: FORD GLOBAL TECHNOLOGIES, LLC, Dearborn, MI (US)

(72) Inventors: Mohammadreza Eftekhari, Novi, MI (US); Giriraj Srinivasan, Troy, MI (US); Patrick Daniel Maguire, Ann Arbor, MI (US); Brian Utley, Canton, MI (US)

(21) Appl. No.: 18/176,709

(22) Filed: Mar. 1, 2023

(51) Int. Cl. H01M 50/30; H01M 50/367

(52) U.S. Cl. CPC H01M 50/394; H01M 50/367; H01M 2220/20

(57) ABSTRACT

Integrated filtering systems are provided for filtering battery vent byproducts (e.g., gases and/or effluent particulates) during battery thermal events of a traction battery pack. The filtering systems may include one or more filters integrated as part of a vent valve, a vent pipe, a pressure equalization device, and/or an array housing of the traction battery pack, and/or as part of a structure that is separate from the traction battery pack. The filter may be configured to filter a constituent element (e.g., carbon monoxide (CO), hydrogen fluoride (HF), etc.) of a gaseous mixture vented from a battery cell of the traction battery pack during a battery thermal event, thereby mitigating the potential for vent gas combustion. The filter may be further configured to control the escape of particulates to surrounding environments.

### TECHNICAL FIELD

This disclosure relates generally to electrified vehicle traction battery packs, and more particularly to integrated filtering systems for filtering battery vent byproducts during a battery thermal event.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, an enclosure assembly, a battery cell housed within the enclosure assembly, and a filter arranged to filter a constituent element of a gaseous mixture vented by the battery cell during a battery thermal event. The filter is integrated as part of a vent valve, a vent pipe, a pressure equalization device, or an array housing of the traction battery pack, or the filter is integrated as part of a structure separate from the traction battery pack.

In a further non-limiting embodiment of the foregoing traction battery pack, the filter is further configured to block a flow of a particulate vented from the battery cell during the battery thermal event.

In a further non-limiting embodiment of either of the foregoing traction battery packs, the filter is received within a housing assembly of the vent valve.

In a further non-limiting embodiment of any of the foregoing traction battery packs, the housing assembly includes a base and a cover.

In a further non-limiting embodiment of any of the foregoing traction battery packs, the filter is disposed within an internal passageway of the vent pipe.

In a further non-limiting embodiment of any of the foregoing traction battery packs, the vent pipe includes a plurality of deflectors that are arranged to establish a tortuous venting path inside the vent pipe.

In a further non-limiting embodiment of any of the foregoing traction battery packs, the vent pipe is attached to a second vent pipe to establish a tortuous venting path.

In a further non-limiting embodiment of any of the foregoing traction battery packs, the filter is integrated into a water-impermeable membrane of the pressure equalization device.

In a further non-limiting embodiment of any of the foregoing traction battery packs, the filter is arranged to cover a venting passage formed through a plate member of the array housing.

In a further non-limiting embodiment of any of the foregoing traction battery packs, the structure is a frame member of an underbody of an electrified vehicle.

In a further non-limiting embodiment of any of the foregoing traction battery packs, the filter includes a frame and a filtering catalyst applied to the frame.

In a further non-limiting embodiment of any of the foregoing traction battery packs, the frame includes a mesh structure.

A traction battery pack according to another exemplary aspect of the present disclosure includes, among other things, an enclosure assembly establishing an interior area, a battery array housed within the interior area, and a vent pipe attached to a wall of the enclose assembly. A filter is positioned within the vent pipe and configured to filter a constituent element of a gaseous mixture vented from a battery cell of the battery array during a battery thermal event.

In a further non-limiting embodiment of the foregoing traction battery pack, the vent pipe is fluidly connected to a vent valve disposed within the wall of the enclosure assembly.

In a further non-limiting embodiment of either of the foregoing traction battery packs, the vent valve includes a second filter that is configured to filter the constituent element of the gaseous mixture.

In a further non-limiting embodiment of any of the foregoing battery packs, the filter is disposed within an internal passageway of the vent pipe.

In a further non-limiting embodiment of any of the foregoing battery packs, the vent pipe includes a plurality of deflectors that are arranged to establish a tortuous venting path inside the vent pipe.

In a further non-limiting embodiment of any of the foregoing battery packs, the vent pipe is attached to a second vent pipe to establish a tortuous venting path.

In a further non-limiting embodiment of any of the foregoing battery packs, the vent pipe is completely outside of the interior area.

In a further non-limiting embodiment of any of the foregoing battery packs, a second filter is integrated as part of an array housing of the battery array.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for an electrified vehicle.

FIG. 3 is a cross-sectional view of the traction battery pack of FIG. 2.

FIG. 4 illustrates a filter integrated within a vent valve.

FIG. 5 illustrates another exemplary filter for a vent valve.

FIG. 6 illustrates a filter integrated within a vent pipe.

FIG. 7 illustrates a tortuous venting path established by a series of vent pipes of a traction battery pack.

FIG. 8 illustrates a plurality of deflectors of a vent pipe of a traction battery pack.

FIG. 9 illustrates a filter integrated within an array housing of a battery array of a traction battery pack.

FIG. 10 illustrates a filter integrated within a pressure equalization device.

FIG. 11 illustrates a filter integrated within a structure separate from a traction battery pack.

### DETAILED DESCRIPTION

This disclosure details integrated filtering systems for filtering battery vent byproducts (e.g., gases and/or effluent particulates) during battery thermal events of a traction battery pack. The filtering systems may include one or more filters integrated as part of a vent valve, a vent pipe, a pressure equalization device, and/or an array housing of the traction battery pack, and/or as part of a structure that is separate from the traction battery pack. The filter may be configured to filter a constituent element (e.g., carbon monoxide (CO), hydrogen fluoride (HF), etc.) of a gaseous mixture vented from a battery cell of the traction battery pack during a battery thermal event, thereby mitigating the potential for combustion of the vent gases. The filter may be further configured to control particulate escape to surrounding environments. These and other features are discussed in greater detail in the following paragraphs of this detailed description.

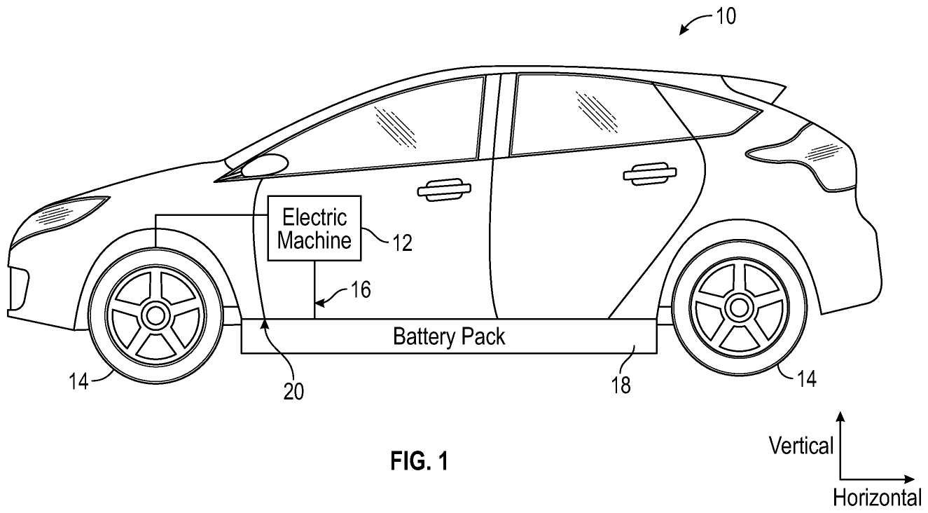

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

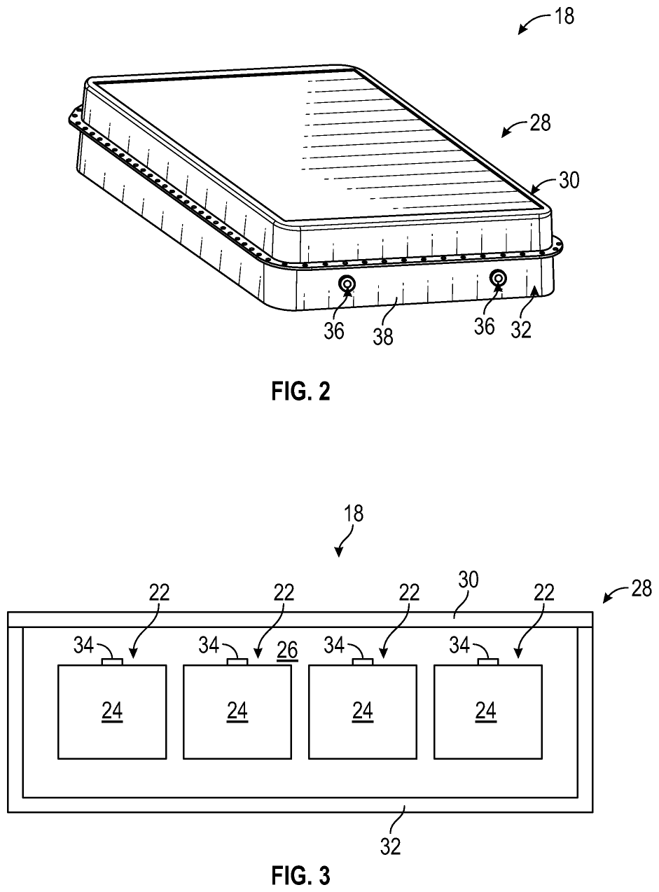

FIGS. 2 and 3 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked side-by-side along a stack axis to construct a grouping of battery cells 24, sometimes referred to as a “cell stack.” In the highly schematic depiction of FIG. 3, the battery cells 24 are stacked in a direction into the page to construct each battery array 22, and thus the battery arrays 22 may extend in cross-car direction. However, other configurations may also be possible. The total number of battery arrays 22 and battery cells 24 provided within the traction battery pack 18 is not intended to limit this disclosure.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

Each battery cell 24 of the traction battery pack 18 may include a vent port 34 (see FIG. 3). The vent ports 34 are configured to expel battery vent byproducts, such as gases, effluent particles, and/or other vent byproducts, from the battery cells 24 during certain battery thermal events. A battery thermal event may occur, for example, during over-charging conditions, over-discharging conditions, or during other conditions.

It is desirable to manage the battery vent byproducts when a battery thermal event occurs. As further discussed below, the traction battery pack 18 may therefore be equipped with features for venting and filtering the battery vent byproducts when a battery thermal event occurs.

Referring now to FIGS. 2, 3, and 4, the traction battery pack 18 may include one or more vent valves 36. Although two vent valves 36 are shown in FIG. 2, the traction battery pack 18 could include a greater or fewer number of such devices.

Each vent valve 36 may be disposed within a wall 38 of the enclosure assembly 28. The wall 38 could be part of the enclosure cover 30, the enclosure tray 32, or both. The exact mounting location of each vent valve 36 could vary and is therefore not intended to limit this disclosure.

The vent valve 36 may be secured to the wall 38 in any manner. In an embodiment, each vent valve 36 is secured within the wall 38 via a quarter turn mount. However, each vent valve 36 could alternatively or additionally be mounted via mechanical fasteners, cam locks, adhesion, etc.

Each vent valve 36 may include a housing assembly 35 and a filter 40 positioned within the housing assembly 35. The housing assembly 35 may include a base 44 and a cover 46. The filter 40 may be received within the base 44, and the cover 46 may be secured to the base 44 for housing the filter 40 inside the housing assembly 35.

The filter 40 may permit a flow of a gaseous mixture G vented from one or more of the battery cells 24 to an area outside of the enclosure assembly 28 during a battery thermal event, and the filter 40 may further block the flow of particulates P (e.g., effluent particles) vented from the one or more battery cells 24 during the battery thermal event. Confining the particulates P to the interior area 26 of the enclosure assembly 28 can mitigate the likelihood of the particulates P becoming an ignition source for igniting the gaseous mixture G that is vented outside the traction battery pack 18 during the battery thermal event.

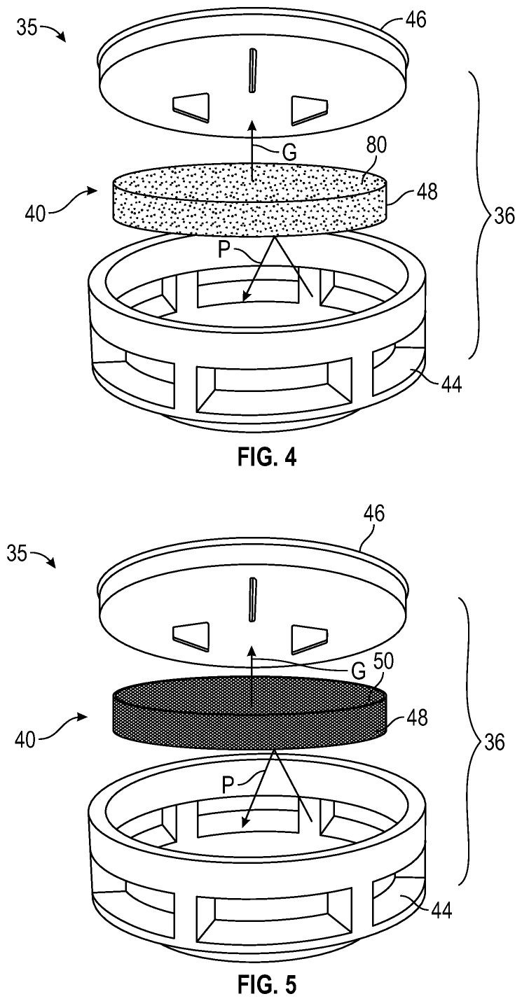

The filter 40 may include a frame 48 configured to block the flow of particulates P. In an embodiment, the frame 48 may be a permeable sheet (see FIG. 4). In an embodiment, the frame 48 includes a mesh structure (see FIG. 5). However, other structures, including woven or non-woven textile structures, could be used. The frame 48 may be made of a high temperature resistance material including but not limited to steel, aluminum, copper, ceramics, high temperature polymers, glass mesh materials, carbon mesh materials, etc.

The filter 40 may additionally include a filtering catalyst 50 that can be applied to the frame 48. The filtering catalyst 50 may be configured to filter the gaseous mixture G in order to reduce the level of one or more constituent elements (e.g., carbon monoxide (CO), hydrogen fluoride (HF), etc.) of the gaseous mixture G. In an embodiment, the filtering catalyst 50 includes an active composite metal oxide capable of providing CO filtration. In another embodiment, the filtering catalyst 50 includes sodium hydroxide or lime for providing HF filtration. In yet another embodiment, the filtering catalyst 50 could be configured to filter both CO and HF and/or any other constituent elements of the gaseous mixture G.

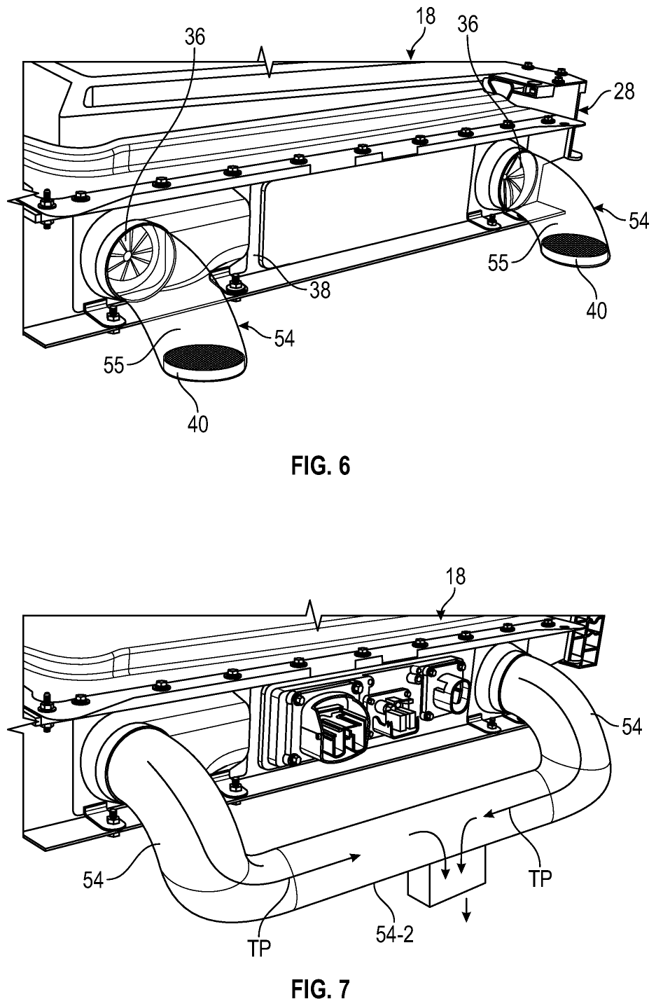

In another embodiment, shown in FIG. 6, the filter 40 may alternatively or additionally be integrated into a vent pipe 54 that is fluidly connected to the vent valve 36 at location outside the traction battery pack 18. Each vent pipe 54 may carry battery vent byproducts vented by the vent valve 36 to a location external to the traction battery pack 18 (e.g., to atmosphere). The filter 40 may be disposed within an internal passageway 55 of the vent pipe 54.

One or more vent pipes 54 may be fluidly connected to each vent valve 36 of the traction battery pack 18. The vent pipes 54 may be mechanically mounted (e.g., welded, bolted, etc.) relative to the wall 38 of the enclosure assembly 28.

In another embodiment, shown in FIG. 7, two or more vent pipes 54 may be connected together (e.g., by an additional vent pipe 54-2) to establish a tortuous venting path TP. The tortuous venting path TP increases the effective length of each vent pipe 54 and can reduce the kinetic energy of the gaseous mixture and the particulates, thereby enabling particle entrainment and diminished ignition capability.

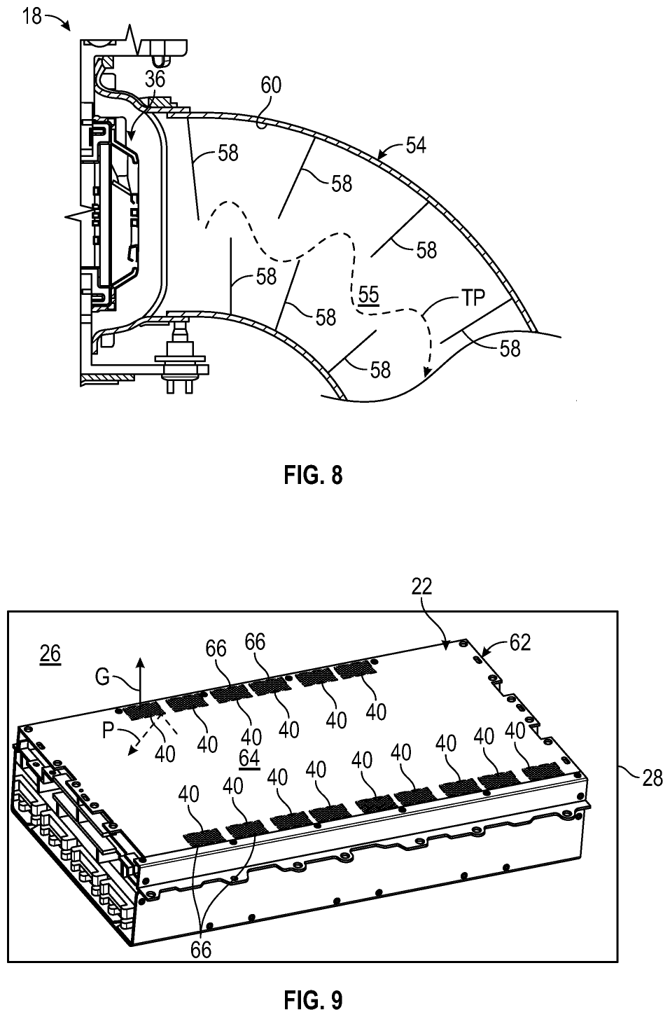

In another embodiment, shown in FIG. 8, each vent pipe 54 may include a plurality of deflectors 58. The deflectors 58 may protrude inwardly from an inner wall 60 of the vent pipe 54 to establish a tortuous venting path TP. The tortuous venting path TP increases the effective length of the vent pipe 54 and can reduce the kinetic energy of the gaseous mixture and the particulates, thereby enabling particle entrainment and diminished ignition capability.

In another embodiment, shown in FIG. 9, the filters 40 may alternatively or additionally be integrated into an array housing 62 of each battery array 22 of the traction battery pack 18. For example, a plate member 64 of the array housing 62 may include a plurality of venting passages 66 for venting battery vent byproducts from inside the array housing 62 to an area outside the array housing 62 (e.g., within the interior area 26 of the enclosure assembly 28). One filter 40 may be positioned to cover each venting passage 66. The filters 40 may permit a flow of gaseous mixture G vented from a battery cell within the array housing 62 to an area outside the array housing 62. The filters 40 may further block a flow of particulates P from escaping through the venting passages 66 into the interior area 26.

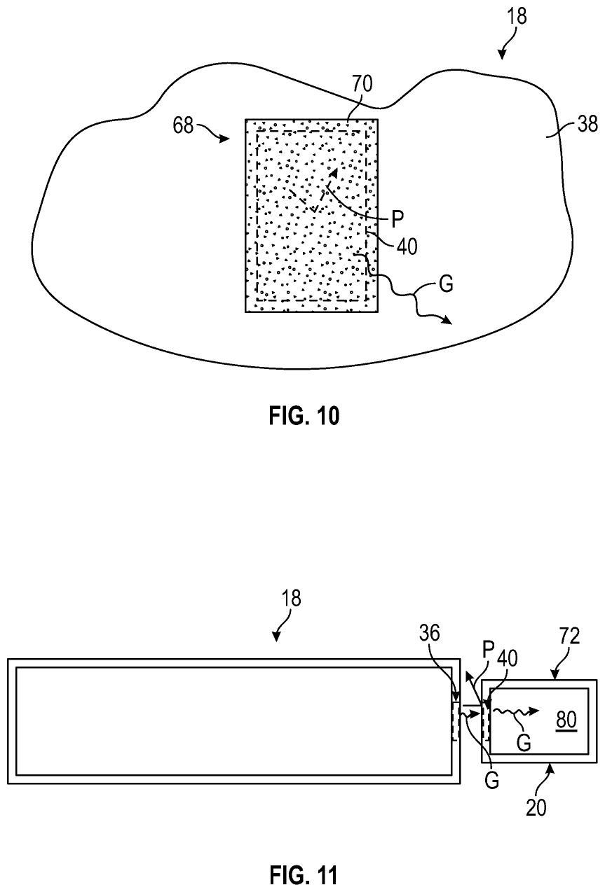

In another embodiment, shown in FIG. 10, the filter 40 may alternatively or additionally be integrated into a pressure equalization device 68 of the traction battery pack 18. The pressure equalization device 68 may include a water-impermeable membrane 70 configured to provide pressure equalization between the interior of the traction battery pack 18 and an atmosphere outside of the traction battery pack 18. The filter 40 may be integrated into the water-impermeable membrane 70 and may be configured for permitting flow of gaseous mixture G vented from a battery cell 24 to an area outside the traction battery pack 18. The filter 40 may further block the flow of particulates P (e.g., effluent particles) vented from the battery cell 24 during a battery thermal event.

In yet another embodiment, shown in FIG. 11, the filter 40 may be integrated into a structure 72 that is mounted near the traction battery pack 18 in a vehicle-mounted position of the traction battery pack 18. For example, the traction battery pack 18 could be arranged to vent in a direction toward the structure 72, such as via a vent valve 36. The filter 40 may permit a flow of gaseous mixture G vented from the traction battery pack 18 to the structure 72 and surrounding areas and may further block the flow of particulates P during a battery thermal event. In an embodiment, the structure 72 is a frame member of the underbody 20 of the electrified vehicle 10. The gaseous mixture G may pass through the filter 40 into a passageway 80 of the structure 72.

Notably, as would be appreciated by a person of ordinary skill in the art having the benefit of this disclosure, the traction battery pack 18 could be equipped with any combination of the filtering devices and techniques described above and shown in FIGS. 4-11.

The exemplary traction battery packs of this disclosure incorporate filters that are capable of selectively filtering gases, controlling particle escape to surrounding environments of the traction battery pack, and mitigating the combustion opportunity of combustible vent gases.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly;
a battery cell housed within the enclosure assembly; and
a filter arranged to filter a constituent element of a gaseous mixture vented by the battery cell during a battery thermal event,
wherein the filter is integrated as part of a vent valve, a vent pipe, a pressure equalization device, or an array housing of the traction battery pack, or
the filter is integrated as part of a structure separate from the traction battery pack.

2. The traction battery pack as recited in claim 1, wherein the filter is further configured to block a flow of a particulate vented from the battery cell during the battery thermal event.

3. The traction battery pack as recited in claim 1, wherein the filter is received within a housing assembly of the vent valve.

4. The traction battery pack as recited in claim 3, wherein the housing assembly includes a base and a cover.

5. The traction battery pack as recited in claim 1, wherein the filter is disposed within an internal passageway of the vent pipe.

6. The traction battery pack as recited in claim 5, wherein the vent pipe includes a plurality of deflectors that are arranged to establish a tortuous venting path inside the vent pipe.

7. The traction battery pack as recited in claim 5, wherein the vent pipe is attached to a second vent pipe to establish a tortuous venting path.

8. The traction battery pack as recited in claim 1, wherein the filter is integrated into a water-impermeable membrane of the pressure equalization device.

9. The traction battery pack as recited in claim 1, wherein the filter is arranged to cover a venting passage formed through a plate member of the array housing.

10. The traction battery pack as recited in claim 1, wherein the structure is a frame member of an underbody of an electrified vehicle.

11. The traction battery pack as recited in claim 1, wherein the filter includes a frame and a filtering catalyst applied to the frame.

12. The traction battery pack as recited in claim 11, wherein the frame includes a mesh structure.

13. A traction battery pack, comprising:
an enclosure assembly establishing an interior area;
a battery array housed within the interior area; and
a vent pipe attached to a wall of the enclose assembly; and
a filter positioned within the vent pipe and configured to filter a constituent element of a gaseous mixture vented from a battery cell of the battery array during a battery thermal event.

14. The traction battery pack as recited in claim 13, wherein the vent pipe is fluidly connected to a vent valve disposed within the wall of the enclosure assembly.

15. The traction battery pack as recited in claim 14, wherein the vent valve includes a second filter that is configured to filter the constituent element of the gaseous mixture.

16. The battery pack as recited in claim 13, wherein the filter is disposed within an internal passageway of the vent pipe.

17. The battery pack as recited in claim 13, wherein the vent pipe includes a plurality of deflectors that are arranged to establish a tortuous venting path inside the vent pipe.

18. The battery pack as recited in claim 13, wherein the vent pipe is attached to a second vent pipe to establish a tortuous venting path.

19. The battery pack as recited in claim 13, wherein the vent pipe is completely outside of the interior area.

20. The battery pack as recited in claim 13, comprising a second filter integrated as part of an array housing of the battery array.
